(19) United States
(12) Patent Application Publication
(10) Pub. No.: US 2024/0279420 A1
(43) Pub. Date: Aug. 22, 2024

(54) POLYOL BLENDED LIQUID COMPOSITION FOR PRODUCTION OF HYDROCHLOROFLUOROOLEFIN BLOWN POLYURETHANE FOAM, AND ITS APPLICATION

(71) Applicant: TOSOH CORPORATION, Yamaguchi (JP)

(72) Inventors: Katsumi TOKUMOTO, Yamaguchi (JP); Yudai TANAKA, Yamaguchi (JP)

(21) Appl. No.: 18/560,037

(22) PCT Filed: May 9, 2022
(86) PCT No.: PCT/JP2022/019674

§ 371 Date: Nov. 9, 2023

(30) Foreign Application Priority Data
May 11, 2021 (JP) 2021-080484
Mar. 28, 2022 (JP) 2022-051036

(51) Int. Cl. C08J 9/14; C08G 18/08; C08G 18/18; C08G 18/44; C08G 101/00

(52) U.S. Cl. CPC C08J 9/147; C08G 18/14; C08G 18/44; C08G 18/18; C08G 2101/00; C08G 2110/0025; C08G 2110/005; C08G 2110/0058; C08J 2203/162; C08J 2205/052; C08J 2205/10; C08J 2375/04

(57) ABSTRACT

Production of a hydrochlorofluoroolefin-based polyurethane foam using a known amine catalyst, has such problems that a mixed liquid does not quickly start blowing reaction, and dropping may occur in spraying process.

A polyol blended liquid composition for production of a polyurethane foam, which comprises:
(i) a carbonate (A) of an amine compound represented by the following formula (1), (2) or (4),
(ii) a blowing agent containing a hydrochlorofluoroolefin (B), and
(iii) a polyol (C):

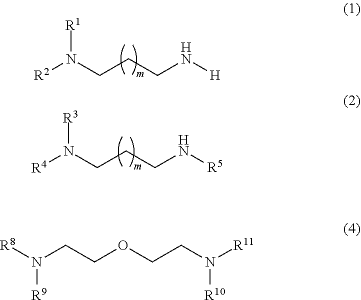

### TECHNICAL FIELD

The present invention relates to a polyol blended liquid used in production of a hydrochlorofluoroolefin blown polyurethane foam. More particularly, it relates to a polyol blended liquid composition containing a polyol, a hydrochlorofluoroolefin and a specific amine carbonate, excellent in initial blowing property and storage stability, and a method for producing a polyurethane foam using the polyol blended liquid composition and an organic polyisocyanate.

### BACKGROUND ART

Polyurethane foams are produced by a reaction of a polyol and an isocyanate, and as typical production, a production method of reacting a polyol blended liquid containing a tertiary amine catalyst, a blowing agent, a surfactant, etc., with an organic polyisocyanate, may be mentioned. In such production of polyurethane foams, it is important that the polyol blended liquid and the organic polyisocyanate are mixed and brought into contact with each other so that they undergo blowing reaction quickly. For example, in spraying process for a heat insulating polyurethane foam, a mixed liquid sprayed over the wall or the like quickly undergoes blowing reaction, thereby to form a favorable foamed resin heat insulating layer.

In recent years, as the blowing agent, hydrochlorofluoroolefins (HCFOs) having low global warming potential are starting to be used. As specific examples of the hydrochlorofluoroolefin, 1-chloro-3,3,3-trifluoropropene (HCFO-1233zd) and 1-chloro-2,3,3,3-tetrafluoropropene (HCFO-1224yd) may be mentioned.

Hydrochlorofluoroolefins are known to decompose with time by the action of the tertiary amine catalyst, and it is known that the reaction of the polyol blended composition with the organic polyisocyanate becomes slow by an acid such as hydrofluoric acid or hydrochloric acid formed with the decomposition. Accordingly, a polyol blended liquid containing a hydrochlorofluoroolefin is not suitable for long term storage, and it is hardly industrially applicable.

To solve the above problem, an example using an organic acid-containing amine catalyst (Patent Document 1) and an example using a sterically hindered amine catalyst (Patent Document 2) have been proposed.

Further, as a technique to miniaturize cells of a polyurethane foam, a method of using a carbonate of a primary or secondary amine (Patent Document 3) and a composite blowing agent containing hexafluorobutene and an alkanolamine salt mixture (Patent Document 4) have been proposed, although they are not related to the above problems.

### PRIOR ART DOCUMENTS

### Patent Documents

Patent Document 1: JP-A-2011-500893
Patent Document 2: WO2009/048807
Patent Document 3: JP-A-2000-239339
Patent Document 4: JP-A-2020-537702

### DISCLOSURE OF INVENTION

### Technical Problem

In the example using an organic acid-containing amine catalyst as describe in Patent Document 1 and the example using a sterically hindered amine catalyst as described in Patent Document 2, there are problems such that the mixed liquid does not quickly start blowing reaction, and dropping occurs in the spraying process.

### Solution to Problem

The present inventors have conducted extensive studies to solve the above problems and as a result found that it is effective to solve the above problems to blend a carbonate of a specific amine compound in a polyol blended liquid for production of a hydrochlorofluoroolefin blown polyurethane foam, and accomplished the present invention.

That is, the present invention relates to the following polyol blended liquid composition for production of a hydrochlorofluoroolefin blown polyurethane foam, and method for producing a polyurethane foam using the polyol blended liquid composition.

[1] A polyol blended liquid composition for production of a polyurethane foam, which comprises:
(i) a carbonate (A) of an amine compound represented by the following formula (1), (2) or (4),
(ii) a blowing agent containing a hydrochlorofluoroolefin (B), and
(iii) a polyol (C):

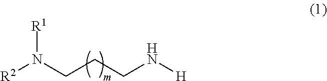

wherein R¹ and R² are each independently a C₂-6 alkyl group which may have a hydroxy group,
R¹ and R² may be bonded to form a morpholine ring, and
m is an integer of from 0 to 4;

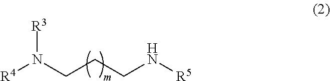

wherein R³ and R⁴ are each independently a C₁₋₆ alkyl group which may have a hydroxy group,
R³ and R⁴ may be bonded to form a morpholine ring,
m is an integer of from 0 to 4, and
R⁵ is a C₁₋₆ alkyl group which may have a hydroxy group, or a group represented by the following formula (3):

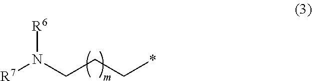

wherein * is a moiety linked to the formula (2),
R⁶ and R⁷ are each independently a C₁₋₆ alkyl group which may have a hydroxy group,
R⁶ and R⁷ may be bonded to form a morpholine ring, and
m is an integer of from 0 to 4;

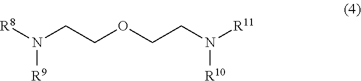

wherein R⁸ and R⁹ are each independently a C₁₋₆ alkyl group which may have a hydroxy group,
R⁸ and R⁹ may be bonded to form a morpholine ring,
R¹⁰ is a hydrogen atom, or a C₁₋₆ alkyl group which may have a hydroxy group,
R¹¹ is a hydrogen atom, a C₁₋₆ alkyl group which may have a hydroxy group, or a group represented by the following formula (5):

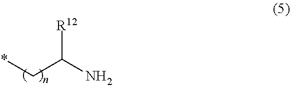

wherein * is a moiety linked to the formula (4),
R¹² is a hydrogen atom or a methyl group, and
n is an integer of from 0 to 2.
   [2] The composition according to [1], wherein in the formula (1), the group represented by —NR¹R² is a diethylamino group, an ethyl(n-propyl)amino group, a di(n-propyl)amino group or a morpholino group.
   [3] The composition according to [1], wherein in the formulae (2) and (3), at least one of the group represented by —NR³R⁴ and the group represented by —NR⁶R⁷, is a dimethylamino group, a diethylamino group, an ethyl(n-propyl)amino group, a di(n-propyl)amino group or a morpholino group.
   [4] The composition according to [1], wherein in the formula (4), the group represented by —NR⁸R⁹ is a dimethylamino group, a diethylamino group, an ethyl(n-propyl)amino group, a di(n-propyl)amino group or a morpholino group.
   [5] The composition according to [1], wherein the carbonate (A) of the amine compound represented by the formula (1), (2) or (4), is a carbonate (A) of at least one amine compound selected from the group consisting of N,N-diethyl-1,2-ethylenediamine, N,N-diethyl-1,3-diaminopropane, N,N-diisopropyl-1,2-ethylenediamine, N,N-isopropyl-1,3-diaminopropane, 4-(2-aminoethyl)morpholine, N-(3-aminopropyl)morpholine, N-(2-aminopropyl)morpholine, N,N-diethyl-N′-methyl-1,2-ethylenediamine, N,N,N′-triethyl-1,2-ethylenediamine, N,N-diethyl-N′-methyl-1,3-propanediamine, N,N,N′-triethyl-1,3-propanediamine, N,N-diethyl-N′-methyl-1,4-butanediamine, N,N,N′-triethyl-1,4-butanediamine, 4-(2-aminoethyl)morpholine, N-(3-aminopropyl)morpholine, N-(2-aminopropyl)morpholine, 3,3′-iminobis(N,N-dimethylpropylamine), 3,3′-iminobis(N,N-diethylpropylamine), 2,2′-iminobis(N,N-diethylethylamine), N-(3-aminopropyl)-N,N′,N′-trimethyl-[2,2′-oxybis(ethylamine)], N-(3-aminopropyl)-N,N′,N′-triethyl-[2,2′-oxybis(ethylamine)] and [2-[2-(diethylamino)ethoxy]ethyl](ethyl)amine.
   [6] The composition according to [1], wherein the carbonate (A) of the amine compound represented by the formula (1), (2) or (4), is a carbonate (A) of at least one amine compound selected from the group consisting of N,N-diethyl-1,2-ethylenediamine, N,N-diethyl-1,3-diaminopropane, N,N-diisopropyl-1,2-ethylenediamine, 3,3′-iminobis(N,N-dimethylpropylamine), 3,3′-iminobis(N,N-diethylpropylamine), 2,2′-iminobis(N,N-diethylethylamine), N-(3-aminopropyl)-N,N′,N′-trimethyl-[2,2′-oxybis(ethylamine)], N-(3-aminopropyl)-N,N′,N′-triethyl-[2,2′-oxybis(ethylamine)] and [2-[2-(diethylamino)ethoxy]ethyl](ethyl)amine.
   [7] The composition according to [1], wherein the hydrochlorofluoroolefin (B) is at least one member selected from the group consisting of 1-chloro-2,3,3,3-tetrafluoropropene, 2-chloro-1,3,3,3-tetrafluoropropene, 1-chloro-1,3,3,3-tetrafluoropropene, 2-chloro-3,3,3-trifluoropropene, 1-chloro-2,3,3-trifluoropropene, 1-chloro-3,3,3-trifluoropropene, 1-chloro-1,3,3-trifluoropropene, 2-chloro-1,3,3-trifluoropropene, 2-chloro-1,1,3-trifluoropropene, 3-chloro-1,2,3-trifluoropropene, 3-chloro-1,1,2-trifluoropropene, 1,2-dichloro-3,3,3-trifluoropropene, 2,3-dichloro-3,3-difluoropropene, 1,2,3-trichloro-3,3-difluoropropene, 2,3-dichloro-1,1-difluoropropene, 2,3,3-trichloro-3-fluoropropene, 1,3-dichloro-2,3,3-trifluoropropene and 1-chloro-2,3,3,4,4,5,5-heptafluoro-1-pentene.
   [8] The composition according to [1], wherein the hydrochlorofluoroolefin (B) is trans-1-chloro-3,3,3-trifluoropropene or 1-chloro-2,3,3,3-tetrafluoropropene.
   [9] The composition according to [1], wherein in the carbonate (A) of the amine compound represented by the formula (1), (2) or (4), the content of carbon dioxide gas as a component of the carbonate, is from 2 to 30 parts by weight per 100 parts by weight of the amine compound represented by the formula (1), (2) or (4).
   [10] The composition according to [1], wherein the weight ratio of the component (A) to the component (C) is such that the component (A) is from 2 to 6 parts by weight per 100 parts by weight of the component (C).
   [11] The composition according to [1], wherein the weight ratio of the component (B) to the component (C) is such that the component (B) is from 10 to 30 parts by weight per 100 parts by weight of the component (C).
   [12] A method for producing a polyurethane foam, which comprises reacting the composition as defined in any one of [1] to [11], with a polyisocyanate compound.

### Advantageous Effects of Invention

The polyol blended liquid of the present invention starts blowing reaction quickly as compared with a conventional polyol blended liquid using an organic acid-containing amine catalyst and a sterically hindered amine catalyst, and thereby suppresses dropping in spraying process.

Further, the polyol blended liquid of the present invention, in which decomposition of a hydrochlorofluoroolefin with time can be suppressed as compared with a conventional polyol blended liquid, can be stored for a longer time.

From the above reasons, the polyol blended liquid of the present invention, which quickly starts blowing reaction without dropping even in the low temperature season particularly in spraying process, and high quality of which can be maintained for a long time even in the high temperature season, achieves remarkable effects such that high quality hydrochlorofluoroolefin blown polyurethane foams can stably be produced without being affected by external temperature changes.

### DESCRIPTION OF EMBODIMENTS

Now, the present invention will be described in detail below.

According to an embodiment of the present invention, provided is a polyol blended liquid composition for production of a polyurethane foam.

The polyol blended liquid composition for production of a polyurethane foam of the present invention comprises (i) a carbonate (A) of an amine compound represented by the following formula (1), (2) or (4), (ii) a blowing agent containing a hydrochlorofluoroolefin (B), and (iii) a polyol (C).

The amine compound represented by the formula (1) is as follows.

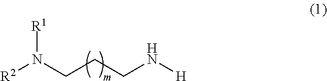

wherein R¹ and R² are each independently a C₂₋₆ alkyl group which may have a hydroxy group,
R¹ and R² may be bonded to form a morpholine ring, and
m is an integer of from 0 to 4.

The amine compound represented by the formula (2) is as follows.

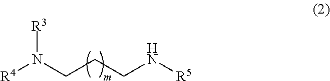

wherein R³ and R⁴ are each independently a C₁₋₆ alkyl group which may have a hydroxy group,
R³ and R⁴ may be bonded to form a morpholine ring,
m is an integer of from 0 to 4, and
R⁶ is a C₁₋₆ alkyl group which may have a hydroxy group, or a group represented by the following formula (3):

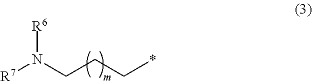

wherein * is a moiety linked to the formula (2),
R⁶ and R⁷ are each independently a C₁₋₆ alkyl group which may have a hydroxy group,
R⁶ and R⁷ may be bonded to form a morpholine ring, and
m is an integer of from 0 to 4.

The amine compound represented by the formula (4) is as follows.

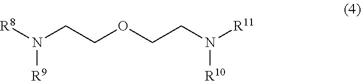

wherein R⁸ and R⁹ are each independently a C₁₋₆ alkyl group which may have a hydroxy group,
R⁸ and R⁹ may be bonded to form a morpholine ring,
R¹⁰ is a hydrogen atom, or a C₁₋₆ alkyl group which may have a hydroxy group,
R¹¹ is a hydrogen atom, a C₁₋₆ alkyl group which may have a hydroxy group, or a group represented by the following formula (5):

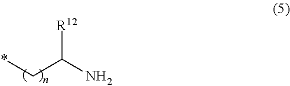

wherein * is a moiety linked to the formula (4),
R¹² is a hydrogen atom or a methyl group, and
n is an integer of from 0 to 2.

The definitions for the formulae (1), (2), (3), (4) and (5) will be described below.

In the formula (1), R¹ and R² are each independently a C₂₋₆ alkyl group which may have a hydroxy group.

The C₂₋₆ alkyl group which may have a hydroxy group, may be expressed as an ethyl group which may have a hydroxy group, or a C₃₋₆ linear, branched or cyclic alkyl group which may have a hydroxy group and is not particularly limited, and may, for example, be an ethyl group, a 2-hydroxyethyl group, a n-propyl group, an i-propyl group, a cyclopropyl group, a 2-hydroxypropyl group, a 3-hydroxypropyl group, a n-butyl group, an i-butyl group, a sec-butyl group, a tert-butyl group, a cyclobutyl group, a 2-hydroxybutyl group, a pentyl group, a 2-hydroxypentyl group, a hexyl group, a cyclohexyl group or a 2-hydroxyhexyl group.

As described above, in the formula (1), R¹ and R² may be bonded to form a morpholine ring.

In the formula (1), m is an integer of from 0 to 4.

In the formula (1), m is an integer of from 0 to 4, and in view of improvement of storage stability of the polyol blended liquid for production of a polyurethane foam containing a hydrochlorofluoroolefin, preferably an integer of from 0 to 2, more preferably 0, 1 or 2, further preferably 0 or 1.

In the amine compound represented by the formula (1), in view of improvement of storage stability of the polyol blended liquid for production of a polyurethane foam containing a hydrochlorofluoroolefin, the group represented by —NR¹R² is preferably a diethylamino group, an ethyl(n-propyl)amino group, a di(n-propyl)amino group or a morpholino group.

The carbonate of the amine compound represented by the formula (1) is, in view of improvement of storage stability of the polyol blended liquid for production of a polyurethane foam containing a hydrochlorofluoroolefin, preferably a carbonate of at least one amine compound selected from the group consisting of N,N-diethyl-1,2-ethylenediamine, N,N-diethyl-1,3-diaminopropane, N,N-diisopropyl-1,2-ethylenediamine, N,N-isopropyl-1,3-diaminopropane, 4-(2-aminoethyl)morpholine, N-(3-aminopropyl)morpholine and N-(2-aminopropyl)morpholine, more preferably carbonate of N,N-diethyl-1,2-ethylenediamine, carbonate of N,N-diethyl-1,3-diaminopropane or carbonate of N,N-diisopropyl-1,2-ethylenediamine.

In the formulae (2) and (3), the C₁₋₆ alkyl group which may have a hydroxy group as each of R³, R⁴, R⁵, R⁶ and R⁷, may be expressed as a methyl group which may have a hydroxy group, an ethyl group which may have a hydroxy group, or a C₃₋₆ linear, branched or cyclic alkyl group which may have a hydroxy group and is not particularly limited, and may, for example, be a methyl group, an ethyl group, a 2-hydroxyethyl group, a n-propyl group, an i-propyl group, a cyclopropyl group, a 2-hydroxypropyl group, a 3-hydroxypropyl group, a n-butyl group, an i-butyl group, a sec-butyl group, a tert-butyl group, a cyclobutyl group, a 2-hydroxybutyl group, a pentyl group, a 2-hydroxypentyl group, a hexyl group, a cyclohexyl group or a 2-hydroxyhexyl group.

As described above, in the formulae (2) and (3), R³ and R⁴, and R⁶ and R⁷, may be bonded to form a morpholine ring.

In the formulae (2) and (3), each m is independently an integer of from 0 to 4, and in view of improvement of storage stability of the polyol blended liquid for production of a polyurethane foam containing a hydrochlorofluoroolefin, preferably an integer of from 0 to 2, more preferably 0, 1 or 2, further preferably 0 or 1.

With respect to the amine compound represented by the formula (2), in view of improvement of storage stability of the polyol blended liquid for production of a polyurethane foam containing a hydrochlorofluoroolefin, in the formulae (2) and (3), at least one of the group represented by —NR³R⁴ and the group represented by —NR⁶R⁷ is preferably a dimethylamino group, a diethylamino group, an ethyl(n-propyl)amino group, a di(n-propyl)amino or a morpholino group.

The carbonate of the amine compound represented by the formula (2) is, in view of improvement of storage stability of the polyol blended liquid for production of a polyurethane foam containing a hydrochlorofluoroolefin, preferably a carbonate of at least one amine compound selected from the group consisting of N,N-diethyl-N′-methyl-1,2-ethylenediamine, N,N,N′-triethyl-1,2-ethylenediamine, N,N-diethyl-N′-methyl-1,3-propanediamine, N,N,N′-triethyl-1,3-propanediamine, N,N-diethyl-N′-methyl-1,4-butanediamine, N,N,N′-triethyl-1,4-butanediamine, 4-(2-aminoethyl)morpholine, N-(3-aminopropyl)morpholine, N-(2-aminopropyl)morpholine, 3,3′-iminobis(N,N-dimethylpropylamine), 3,3′-iminobis(N,N-diethylpropylamine) and 2,2′-iminobis(N,N-diethylethylamine), more preferably carbonate of 3,3′-iminobis(N,N-dimethylpropylamine), carbonate of 3,3′-iminobis(N,N-diethylpropylamine) or carbonate of 2,2′-iminobis(N,N-diethylethylamine).

In the formula (4), the C₁₋₆ alkyl group which may have a hydroxy group as each of R⁸, R⁹, R¹⁰ and R¹¹, may be expressed as a methyl group which may have a hydroxy group, an ethyl group which may have a hydroxy group, or a C₃₋₆ linear, branched or cyclic alkyl group which may have a hydroxy group and is not particularly limited, and may, for example, be a methyl group, an ethyl group, a 2-hydroxyethyl group, a n-propyl group, an i-propyl group, a cyclopropyl group, a 2-hydroxypropyl group, a 3-hydroxypropyl group, a n-butyl group, an i-butyl group, a sec-butyl group, a tert-butyl group, a cyclobutyl group, a 2-hydroxybutyl group, a pentyl group, a 2-hydroxypentyl group, a hexyl group, a cyclohexyl group or a 2-hydroxyhexyl group.

As described above, in the formula (4), R⁸ and R⁹ may be bonded to form a morpholine ring.

In the formula (5), n is an integer of from 0 to 2, and in view of improvement of storage stability of the polyol blended liquid for production of a polyurethane foam containing a hydrochlorofluoroolefin, preferably 1 or 2, further preferably 2.

With respect to the amine compound represented by the formula (4), in view of improvement of storage stability of the polyol blended liquid for production of a polyurethane foam containing a hydrochlorofluoroolefin, in the formula (4), the group represented by —NR⁸R⁹ is preferably a dimethylamino group, a diethylamino group, an ethyl(n-propyl)amino group, a di(n-propyl)amino group, an imidazole group or a morpholino group.

The carbonate of the amine compound represented by the formula (4) is, in view of improvement of storage stability of the polyol blended liquid for production of a polyurethane foam containing a hydrochlorofluoroolefin, preferably a carbonate (A) of at least one amine compound selected from the group consisting of N-(3-aminopropyl)-N,N′,N′-trimethyl-[2,2′-oxybis(ethylamine)], N-(3-aminopropyl)-N,N′,N′-triethyl-[2,2′-oxybis(ethylamine)] and [2-[2-(diethylamino)ethoxy]ethyl](ethyl)amine.

As described above, the carbonate (A) of an amine compound represented by the formula (1), (2) or (4) is, from the viewpoint of initial blowing property in production of a polyurethane foam, preferably a carbonate (A) of at least one amine compound selected from the group consisting of N,N-diethyl-1,2-ethylenediamine, N,N-diethyl-1,3-diaminopropane, N,N-diisopropyl-1,2-ethylenediamine, N,N-isopropyl-1,3-diaminopropane, 4-(2-aminoethyl)morpholine, N-(3-aminopropyl)morpholine, N-(2-aminopropyl)morpholine, N,N-diethyl-N′-methyl-1,2-ethylenediamine, N,N,N′-triethyl-1,2-ethylenediamine, N,N-diethyl-N′-methyl-1,3-propanediamine, N,N,N′-triethyl-1,3-propanediamine, N,N-diethyl-N′-methyl-1,4-butanediamine, N,N,N′-triethyl-1,4-butanediamine, 4-(2-aminoethyl)morpholine, N-(3-aminopropyl)morpholine, N-(2-aminopropyl)morpholine, 3,3′-iminobis(N,N-dimethylpropylamine), 3,3′-iminobis(N,N-diethylpropylamine), 2,2′-iminobis(N,N-diethylethylamine), N-(3-aminopropyl)-N,N′,N′-trimethyl-[2,2′-oxybis(ethylamine)], N-(3-aminopropyl)-N,N′,N′-triethyl-[2,2′-oxybis(ethylamine)] and [2-[2-(diethylamino)ethoxy]ethyl](ethyl)amine, more preferably a carbonate (A) of at least one amine compound selected from the group consisting of N,N-diethyl-1,2-ethylenediamine, N,N-diisopropyl-1,2-ethylenediamine, N,N-diethyl-1,3-diaminopropane, 3,3′-iminobis(N,N-dimethylpropylamine), 3,3′-iminobis(N,N-diethylpropylamine), 2,2′-iminobis(N,N-diethylethylamine), N-(3-aminopropyl)-N,N′,N′-trimethyl-[2,2′-oxybis(ethylamine)], N-(3-aminopropyl)-N,N′,N′-triethyl-[2,2′-oxybis(ethylamine)] and [2-[2-(diethylamino)ethoxy]ethyl](ethyl)amine, particularly preferably carbonate of N,N-diethyl-1,2-ethylenediamine, carbonate of N,N-diethyl-1,3-diaminopropane, carbonate of N,N-diisopropyl-1,2-ethylenediamine, carbonate of 3,3′-iminobis(N,N-dimethylpropylamine) or carbonate of N-(3-aminopropyl)-N,N′,N′-trimethyl-[2,2′-oxybis(ethylamine)].

The carbonate (A) of an amine compound means a mixture of an amine compound and carbon dioxide. The mixture ratio of the amine compound to carbon dioxide in the carbonate (A) of the amine compound is not particularly limited, and for example, in view of excellent blowing property of the polyurethane foam, the amount of carbon dioxide is from 0.1 to 1.0 times the molar quantity per one amino group of the amine compound, more preferably from 0.2 to 0.5 times the molar quantity. For example, in the case of an amine compound having two amino groups, per mol of the amine compound, the amount of carbon dioxide mixed is preferably from 0.2 to 2 mol, more preferably from 0.4 to 1.0 mol. In the case of an amine compound having three amino groups, per mol of the amine compound, the amount of carbon dioxide mixed is preferably from 0.3 to 3 mol, more preferably from 0.6 to 1.5 mol.

In the carbonate (A) of the amine compound, the content of carbon dioxide as a component of the carbonate is not particularly limited, and for example, in view of excellent blowing property of the polyurethane foam, per 100 parts by weight of the amine compound, preferably from 1 to 50 parts by weight, more preferably from 1 to 40 parts by weight, further preferably from 2 to 30 parts by weight, further more preferably from 3 to 20 parts by weight.

As described above, the polyol blended liquid composition for production of a polyurethane foam of the present invention is characterized by containing (i) the carbonate (A) of the amine compound represented by the formula (1), (2) or (4), (ii) a blowing agent containing a hydrochlorofluoroolefin (B) and (iii) a polyol (C), and as the carbonate (A) of the amine compound represented by the formula (1), (2) or (4), one without a solvent may be used, or one dissolved in a solvent (one containing a solvent) may be used.

In a case where the carbonate (A) of the amine compound represented by the formula (1), (2) or (4) is solid at ordinary temperature, in view of workability, one dissolved in a solvent is preferably used. The solvent is not particularly limited and may, for example, be water, ethylene glycol, diethylene glycol, dipropylene glycol or butanediol. In a case where the carbonate (A) of the amine compound represented by the formula (1), (2) or (4) contains such a solvent, the polyol blended liquid composition for production of a polyurethane foam of the present invention contains, in addition to the above (i), (ii) and (iii), the solvent. The solvent may sometimes be utilized as a part of the after-described polyol, blowing agent or crosslinking agent.

In a case where a carbonate (A) of the amine compound represented by the formula (1), (2) or (4) containing a solvent is used, the content of the solvent is not particularly limited, and in view of minimizing the influence over physical properties of the foam, it is preferably 50 wt % or less, more preferably 20 wt % or less, further preferably 10 wt % or less, to the total weight of the carbonate (A) of the amine compound and the solvent.

The polyol blended liquid composition of the present invention is characterized by containing a polyol (C).

In the polyol blended liquid composition of the present invention, the polyol (C) is not particularly limited, and may, for example, be a known polyester polyol, polyether polyol or polymer polyol. Such a polyol may be used alone or as a mixture.

As a known polyester polyol, usually, a polymerization reaction product of a dibasic acid (such as adipic acid, phthalic acid, succinic acid, azelaic acid, sebacic acid or ricinoleic acid) and a hydroxy compound (such as glycol) may be mentioned. Specific examples of the polyester polyol are not particularly limited, and include a polyester polyol formed from a by-product in production of DMT (dimethyl terephthalate) or a by-product in production of phthalic anhydride as a starting material, a by-product in production of nylon, a by-product in production of TMP (trimethylolpropane), a by-product in production of pentaerythritol or a by-product in production of phthalic acid-based polyester.

As a known polyether polyol, an active hydrogen-containing compound such as a polyhydric alcohol (such as glycol, glycerin, pentaerythritol, trimethylolpropane, sorbitol or sucrose), an aliphatic amine compound (such as ammonia, ethylenediamine or ethanolamine), an aromatic amine compound (such as toluenediamine or diphenylmethane-4,4′-diamine) or a Mannich polyol, and one obtained by reacting such an active hydrogen-containing compound with ethylene oxide and/or propylene oxide, may, for example, be mentioned.

As a known polymer polyol, one obtained by reacting the above polyether polyol with an ethylenically unsaturated monomer (such as butadiene, acrylonitrile or styrene) in the presence of a radical polymerization catalyst may be mentioned.

Among such polyols, in view of suitability for production of a rigid polyurethane foam, preferred is a polyether or polyester polyol. Further, in view of suitability for production of a rigid polyurethane foam, the average functionality of the polyol is preferably from 4 to 8, and the average hydroxy value of the polyol is preferably from 200 to 800 mgKOH/g, more preferably from 300 to 700 mgKOH/g.

In the polyol blended liquid composition of the present invention, the content of the carbonate (A) of the amine compound represented by the formula (1), (2) or (4) is not particularly limited, and per 100 parts by weight of the polyol (C), it is preferably from 0.1 to 100 parts by weight, more preferably from 0.1 to 50 parts by weight, further preferably from 0.1 to 10 parts by weight, further more preferably from 2 to 6 parts by weight, still more preferably from 3 to 5 parts by weight.

The polyol blended liquid composition of the present invention is characterized by containing a blowing agent containing a hydrochlorofluoroolefin (B).

The hydrochlorofluoroolefin (B) is not particularly limited and for example, preferably one having global warming potential (GWP) of 150 or less, more preferably 100 or less, further preferably 75 or less.

The hydrochlorofluoroolefin (B) is not particularly limited and for example, preferably one having ozone depletion potential (ODP) of 0.05 or less, more preferably 0.02 or less, further preferably 0.01 or less.

The hydrochlorofluoroolefin (B) is not particularly limited and may, for example, be 1-chloro-2,3,3,3-tetrafluoropropene (HCFO-1224yd), 2-chloro-1,3,3,3-tetrafluoropropene (HCFO-1224xe), 1-chloro-1,3,3,3-tetrafluoropropene (HCFO-1224zb), 2-chloro-3,3,3-trifluoropropene (HCFO-1233xf), 1-chloro-2,3,3-trifluoropropene (HCFO-1233yd), 1-chloro-3,3,3-trifluoropropene (HCFO-1233zd), 1-chloro-1,3,3-trifluoropropene (HCFO-1233zb), 2-chloro-1,3,3-trifluoropropene (HCFO-1233xe), 2-chloro-1,1,3-trifluoropropene (HCFO-1233xc), 3-chloro-1,2,3-trifluoropropene (HCFO-1233ye), 3-chloro-1,1,2-trifluoropropene (HCFO-1233yc), 1,2-dichloro-3,3,3-trifluoropropene (HCFO-1223xd), 2,3-dichloro-3,3-difluoropropene (HCFO-1232xf), 1,2,3-trichloro-3,3-difluoropropene (HCFO-1222xd), 2,3-dichloro-1,1-difluoropropene (HCFO-1232xc), 2,3,3-trichloro-3-fluoropropene (HCFO-1231xf), 1,3-dichloro-2,3,3-trifluoropropene (HCFO-1223yd) or 1-chloro-2,3,3,4,4,5,5-heptafluoro-1-pentene (HCFO-1437dycc). Such exemplified hydrochlorofluoroolefins include all structural isomers, geometrical isomers and steric isomers. The above specifically exemplified hydrochlorofluoroolefins (B) may be used alone or as a mixture of two or more.

Among such hydrochlorofluoroolefins (B), in view of excellent heat insulating performance of the polyurethane foam, preferred is trans-1-chloro-3,3,3-trifluoropropene (HCFO-1233zd(E)) or 1-chloro-2,3,3,3-tetrafluoropropene (HCFO-1224yd(Z)). The above specifically exemplified hydrochlorofluoroolefins (B) may be used alone or as a mixture of two or more.

The blowing agent containing the hydrochlorofluoroolefin (B) may be a blowing agent consisting solely of the hydrochlorofluoroolefin (B) or may be a blowing agent containing the hydrochlorofluoroolefin (B) and other blowing agent.

Such other blowing agent is not particularly limited and may, for example, be water, formic acid, an organic acid compound (such as acetic acid, propionic acid, reacted with an isocyanate group to generate CO₂), an ether, a halogenated ether, a hydrocarbon (such as isobutane, n-pentane, isopentane or cyclopentane) or a hydrofluoroolefin. The exemplified other blowing agents may be used alone or as a mixture of two or more.

As described above, the blowing agent may consist solely of the above hydrochlorofluoroolefin (B) or may be a mixture of the above hydrochlorofluoroolefin (B) and other blowing agent. In the case of a mixture of the hydrochlorofluoroolefin (B) and other blowing agent, the content of the hydrochlorofluoroolefin (B) in the blowing agent is, to the total weight of the blowing agent, preferably from 5 to 90 wt %, more preferably from 7 to 80 wt %, further preferably from 10 to 70 wt %. On the other hand, the content of other blowing agent is, to the total weight of the blowing agent, preferably from 10 to 95 wt %, more preferably from 20 to 93 wt %, further preferably from 30 to 90 wt %.

In the polyol blended liquid composition of the present invention, the content of the blowing agent containing the hydrochlorofluoroolefin (B) is not particularly limited and may be from 0.1 to 100 parts by weight per 100 parts by weight of the polyol (C), however, from the viewpoint of the heat insulating performance of the polyurethane foam, it is preferably from 1 to 50 parts by weight, more preferably from 10 to 30 parts by weight, further preferably from 15 to 25 parts by weight.

The polyol blended liquid composition of the present invention may contain a component other than the above (i), (ii), (iii), the solvent and other blowing agent, and such other component is not particularly limited and may, for example, be a quaternary ammonium salt compound, an organic metal catalyst compound, a foam stabilizer, a crosslinking agent, a chain extending agent, a solvent, a coloring agent, a flame retardant, an antioxidant or other known additive.

The quaternary ammonium salt compound is not particularly limited and may, for example, be a tetraalkylammonium halide such as tetramethylammonium chloride, a tetraalkylammonium hydroxide such as tetramethylammonium hydroxide, a tetraalkylammonium organic acid salt such as tetramethylammonium acetate or tetramethylammonium 2-ethylhexanoate, or a hydroxyalkylammonium organic acid salt such as 2-hydroxypropyltrimethylammonium formate or 2-hydroxypropyltrimethylammonium 2-ethylhexanoate.

In the polyol blended liquid composition of the present invention, the content of the quaternary ammonium salt compound is not particularly limited and may be from 0.1 to 100 parts by weight per 100 parts by weight of the polyol (C).

The organic metal catalyst compound is not particularly limited and may, for example, be stannous diacetate, stannous dioctoate, stannous dioleate, stannous dilaurate, dibutyltin oxide, dibutyltin diacetate, dibutyltin dilaurate, dibutyltin dichloride, dioctyltin dilaurate, lead octanoate, lead naphthenate, nickel naphthenate or cobalt naphthenate.

In the polyol blended liquid composition of the present invention, the content of the organic metal catalyst compound is not particularly limited and may be from 0.01 to 10 parts by weight per 100 parts by weight of the polyol (C).

The foam stabilizer is not particularly limited and may, for example, be a known silicone foam stabilizer, specifically, a nonionic surfactant such as an organosiloxane-polyoxyalkylene copolymer or a silicone-grease copolymer. Such silicone foam stabilizers may be used alone or as a mixture.

The crosslinking agent or the chain extending agent is not particularly limited and may, for example, be a low molecular weight polyhydric alcohol such as ethylene glycol, diethylene glycol, 1,4-butanediol or glycerin, a low molecular weight amine polyol such as diethanolamine or triethanolamine, or a polyamine such as ethylenediamine, xylylenediamine or methylene-bis-ortho-chloroaniline.

The types of such additives (the quaternary ammonium salt compound, the organic metal catalyst compound, the foam stabilizer, the crosslinking agent, the chain extending agent, the solvent, the coloring agent, the flame retardant, the antioxidant) and their contents in the polyol blended liquid composition are preferably such that a commonly used additive is used in a commonly employed content.

The content of the crosslinking agent and the chain extending agent is not particularly limited and is preferably 70 parts by weight or less per 100 parts by weight of the polyol (C).

The polyol blended liquid composition of the present invention, when mixed by stirring with a polyisocyanate and reacted, can produce a polyurethane resin. The polyurethane resin is not particularly limited and may, for example, be a rigid polyurethane foam or an isocyanurate modified rigid polyurethane foam.

The polyisocyanate may, for example, be a known polyisocyanate, specifically, for example, an aromatic polyisocyanate such as toluene diisocyanate (TDI), a TDI derivative, diphenylmethane diisocyanate (MDI), a MDI derivative, naphthylene diisocyanate or xylylene diisocyanate, an alicyclic polyisocyanate such as isophorone diisocyanate, an aliphatic polyisocyanate such as hexamethylene diisocyanate, a free isocyanate-containing prepolymer obtained by a reaction of the polyisocyanate with a polyol, a modified polyisocyanate such as carbodiimide-modified polyisocyanate, or a mixed polyisocyanate thereof.

The toluene diisocyanate (TDI) may, for example, be 2,4-toluene diisocyanate or 2,6-toluene diisocyanate, and they may be used alone or as a mixture. The TDI derivative may, for example, be a TDI prepolymer having a terminal isocyanate group, which is a reaction product of TDI and a polyol.

The diphenylmethane diisocyanate (MDI) may, for example, be 4,4′-diphenylmethane diisocyanate or 4,2′-diphenylmethane diisocyanate, and they may be used alone or as a mixture. The MDI derivative may, for example, be polyphenylpolymethylene diisocyanate which is a polymer of MDI, or a MDI prepolymer having a terminal isocyanate group, which is a reaction product of MDI and a polyol.

Among them, in view of suitability for production of a rigid polyurethane foam, preferred is MDI or a MDI derivative, and they may be used as mixed.

A rigid polyurethane foam usually has a highly crosslinked closed cell structure and is an irreversible foam, and has properties totally different from those of a flexible foam and a semirigid foam. Physical properties of the rigid polyurethane foam are not particularly limited and generally, the density is preferably from 20 to 100 kg/m³, and the compressive strength is preferably from 0.5 to 10 kgf/cm² (50 to 1,000 kPa).

A polyurethane resin produced by using the polyol blended liquid composition of the present invention can be used for various applications. For example, applications to heat insulating building materials, heat insulating materials for freezers and heat insulating materials for refrigerators may be mentioned.

### EXAMPLES

Now, the present invention will be described in further detail with reference to Examples and Comparative Examples. However, it should be understood that the present invention is by no means restricted thereto.

### Preparation Example 1: Synthesis of N-(3-aminopropyl)-N,N′,N′-trimethyl-[2,2′-oxybis(ethanamine)]

Into a stainless steel autoclave (hereinafter referred to as “reactor 1”) having a capacity of 2 L, 499 g of dimethylaminoethoxy ethanol (3.8 mol) and 38 g of copper/zinc oxide/alumina catalyst were charged. The reactor 1 was purged with nitrogen and hydrogen, and the catalyst was subjected to reduction treatment in the system over a period of 9 hours under a hydrogen pressure of 5.6 MPa at 195° C. The reactor 1 was cooled to 25° C. and depressurized to the atmospheric pressure, and utilizing 0.7 MPa of nitrogen pressure, 177 g of monomethylamine (5.7 mol) was injected into the reactor 1. The pressure in the reactor 1 was elevated again to 1.5 MPa by hydrogen and the reactor 1 was heated to 195° C., and the temperature and the pressure were maintained for 24 hours. By distillation, 326 g of a distillate was obtained from the obtained reaction liquid. The main components of the distillate were N,N,N′-trimethylbis(aminoethyl)ether and dimethylaminoethoxyethanol.

Then, 326 g of the distillate was charged into a three-necked flask equipped with a condenser, the flask was heated to 55° C., and 71 g of acrylonitrile (1.3 mol) was poured into the distillate over a period of 2 hours. Temperature control and stirring were conducted for 5 hours. As a result, reaction product A in which N,N,N′-trimethylbis(aminoethyl)ether (raw material component) was decreased to 1% or less was obtained.

Then, into a stainless steel autoclave (hereinafter referred to as reactor 2) having a capacity of 1 L, 20 g of chromium-added sponge nickel catalyst and 150 g of a 28 wt % aqueous ammonium hydroxide solution were charged. The reactor 2 was purged with nitrogen and hydrogen, heated to 90° C., and pressurized to 8.2 MPa by hydrogen. The entire reaction product A obtained by the above reaction was supplied to the reactor 2 by a pump over a period of 3.5 hours, and temperature control and stirring were conducted for 1 hour. The pressure in the reactor 2 was released, and the reaction liquid in the reactor 2 was taken out. The catalyst was removed from the reaction liquid by filtration, and the reaction liquid was subjected to distillation under reduced pressure (column top temperature: 124 to 133° C., degree of vacuum: 13 hPa) to obtain 140 g of N-(3-aminopropyl)-N,N′,N′-trimethyl-[2,2′-oxybis(ethanamine)].

### Production Example 1

Into a 190 cc pressure container, 26.0 g (0.20 mol) of N,N-diethyl-1,3-diaminopropane (manufactured by Tokyo Chemical Industry Co., Ltd.) and 3.6 g (0.20 mol) of pure water were charged, and the pressure container was sealed. The charged liquid was stirred by a magnetic stirrer, and while the temperature in the container was kept at 25° C., carbon dioxide was blown into a gaseous phase over a period of 15 hours, to obtain 35.8 g of a reaction liquid (aqueous N,N-diethyl-1,3-diaminopropane carbonate solution).

The composition of the reaction liquid calculated from the weight of the carbon dioxide absorbed was as follows.
N,N-Diethyl-1,3-diaminopropane: 74.6 wt %
Pure water: 8.3 wt %
Carbon dioxide: 17.1 wt %
This composition is taken as (A-1).

### Production Example 2

The same operation as in Production Example 1 was conducted except that 37.5 g (0.20 mol) of 3,3′-iminobis(N,N-dimethylpropylamine) (manufactured by Tokyo Chemical Industry Co., Ltd.) was used instead of 26.0 g (0.20 mol) of N,N-diethyl-1,3-diaminopropane (manufactured by Tokyo Chemical Industry Co., Ltd.) to obtain 45.8 g of reaction liquid (aqueous 3,3′-iminobis(N,N-dimethylpropylamine carbonate solution).

The composition of the reaction liquid was estimated as follows from the weight of the carbon dioxide absorbed.
3,3′-Iminobis(N,N-dimethylpropylamine): 81.9 wt %
Pure water: 7.9 wt %
Carbon dioxide: 10.3 wt %

This composition is taken as (A-2).

### Production Example 3

The same operation as in Production Example 1 was conducted except that 40.7 g (0.20 mol) of N-(3-aminopropyl)-N,N′,N′-trimethyl-[2,2′-oxybis(ethanamine)](synthesized product prepared in the above Preparation Example 1) was used instead of 26.0 g (0.20 mol) of N,N-diethyl-1,3-diaminopropane (manufactured by Tokyo Chemical Industry Co., Ltd.) to obtain 49.1 g of reaction liquid (aqueous N-(3-aminopropyl)-N,N′,N′-trimethyl-[2,2′-oxybis(ethanamine)] carbonate solution).

The composition of the reaction liquid was estimated as follows from the weight of the carbon dioxide absorbed.
N-(3-Aminopropyl)-N,N′,N′-trimethyl-[2,2′-oxybis(ethanamine)]: 82.9 wt %
Pure water: 7.3 wt %
Carbon dioxide: 9.8 wt %

This composition is taken as (A-3).

Now, Production Examples for production of polyurethane foam and evaluations results will be described. Raw materials used in the present invention, other than the above compounds, were as follows.
Polyol A: MAXIMOL RDK-133 (aromatic polyester polyol, OH value: 319 mgKOH/g, manufactured by Kawasaki Kasei Chemicals Ltd.)
Polyol B: DK polyol 3776 (Mannich polyether polyol, OH value: 349 mgKOH/g, manufactured by DKS Co., Ltd.)
Flame retardant: TMCPP (halogenated phosphate ester, manufactured by DAIHACHI CHEMICAL INDUSTRY CO., LTD.)
Foam stabilizer: NIAX (registered trademark) SILICONE L-5420 (silicone foam stabilizer, manufactured by Momentive Performance Materials Japan LLC)
Blowing agent A: Solstice (registered trademark) LBA (1-chloro-3,3,3-trifluoropropene, manufactured by Honeywell Japan Ltd.)
Blowing agent B: water
Polyisocyanate liquid: Polymeric MDI (manufactured by Tosoh Corporation, Millionate (registered trademark) MR200, NCO content: 31.0%)

### Example 1

A rigid polyurethane foam was produced by using the catalyst for production of a polyurethane foam of the present invention.

70 Parts by weight of polyol A, 30 parts by weight of polyol B, 20 parts by weight of flame retardant and 2.0 parts by weight of foam stabilizer A were weighed, and thoroughly stirred and mixed to obtain a mixture. 36.6 g of the mixture was put in a 300 ml polyethylene cup, and 1.21 g of the composition (A-1) (in an amount of 4.02 parts by weight per 100 parts by weight of polyol (A+B) and in such an amount that the amount of the amine added in the composition (A-1) would be 3 parts by weight and the amount of the amine carbonate added in the composition (A-1) would be 3.69 parts by weight) was added, 0.50 g of blowing agent B (water) (in an among such that the total amount of water in the composition (A-1) and blowing agent B (water) would be 2 parts by weight per 100 parts by weight of polyol (A+B)) was added, and 4.5 g of blowing agent A (in an amount corresponding to 15.0 parts by weight per 100 parts by weight of polyol (A+B)) was added to produce a polyol blended liquid composition. The obtained polyol blended liquid composition was adjusted to a temperature of 20° C.

The composition of the obtained polyol blended liquid composition was as follows.

TABLE 1

| | Content (parts |
|---|---|
| | by weight) |
| Polyol (A + B) | 100 |
| Flame retardant (TMCPP) | 20 |
| Foam stabilizer A (NIAX SILICONE L-5420) | 2 |
| Amine carbonate in composition (A-1) | 3.69 |
| (excluding water) | |
| Blowing agent B (water) | 2 |
| 1-Chloro-3,3,3-trifluoropropene | 15 |

Into the 300 ml polyethylene cup in which 42.8 g of the polyol blended liquid composition adjusted to a temperature of 20° C. was put, 37.3 g of polyisocyanate liquid (Millionate MR200) adjusted to a temperature of 20° C. (in an amount such that the isocyanate index [[isocyanate group]/[OH group](molar ratio)×100]] would be 110) was put and then quickly stirred by a stirring machine at 7,000 rpm for 2 seconds, the stirred mixture was put in a 1 L polyethylene cup adjusted to a temperature of 23° C. to conduct blowing reaction, and reactivity during foaming was measured by the following method. Further, from the obtained rigid polyurethane foam, the center portion was cut out and the core density was recorded.

### [Measurement of Reactivity]

Cream time: the time was visually measured when the stirred mixture whitened and the foam started expanding.

### [Core Density of Polyurethane Foam]

Core density: The center portion of the foam which had hardened in the 1 L polyethylene cup was cut into 10×6×6 cm, and its weight was measured to obtain the core density.

Then, the polyol blended composition produced by the above method was put in a sealed container and stored in a constant temperature chamber at 40° C. for 7 days, and then the blowing reaction was conducted under the same conditions as above, and [Measurement of reactivity] and evaluation of [Core density of polyurethane foam] were conducted. The results are shown in Table 4.

### Example 2

The same operation as in Example 1 was conducted except that the composition (A-2) was used instead of the composition (A-1) and the addition amounts were changed to produce a polyol blended liquid composition having the following composition.

TABLE 2

| | Content (parts |
|---|---|
| | by weight) |
| Polyol (A + B) | 100 |
| Flame retardant (TMCPP) | 20 |
| Foam stabilizer A (NIAX SILICONE L-5420) | 2 |
| Amine carbonate in composition (A-2) | 3.37 |
| (excluding water) | |
| Blowing agent B (water) | 2 |
| 1-Chloro-3,3,3-trifluoropropene | 15 |

Using the produced polyol blended liquid composition, blowing reaction was conducted under the same conditions as in Example 1, and evaluation was conducted in the same manner as in Example 1. The results are shown in Table 5.

### Example 3

The same operation as in Example 1 was conducted except that the composition (A-3) was used instead of the composition (A-1) and the addition amounts were changed to produce a polyol blended liquid composition having the following composition.

TABLE 3

| | Content (parts |
|---|---|
| | by weight) |
| Polyol (A + B) | 100 |
| Flame retardant A (TMCPP) | 20 |
| Foam stabilizer (NIAX SILICONE L-5420) | 2 |
| Amine carbonate in composition (A-3) | 3.36 |
| (excluding water) | |
| Blowing agent B (water) | 2 |
| 1-Chloro-3,3,3-trifluoropropene | 15 |

Using the produced polyol blended liquid composition, blowing reaction was conducted under the same conditions as in Example 1, and evaluation was conducted in the same manner as in Example 1. The results are shown in Table 6.

### Comparative Example 1

The same operation as in Example 1 was conducted except that 3.00 parts by weight of N,N-diethyl-1,3-diaminopropane was used instead of 4.02 parts by weight of the composition (A-1) to obtain evaluation results. The results are shown in Table 4.

### Comparative Example 2

The same operation as in Example 2 was conducted except that 3.00 parts by weight of 3,3′-iminobis(N,N-dimethylpropylamine) was used instead of 3.66 parts by weight of the composition (A-2) to obtain evaluation results. The results are shown in Table 4.

### Comparative Example 3

The same operation as in Example 3 was conducted except that 3.00 parts by weight of N-(3-aminopropyl)-N,N′,N′-trimethyl-[2,2′-oxybis(ethanamine)] prepared in Preparation Example 1 was used instead of 3.62 parts by weight of the composition (A-3) to obtain evaluation results. The results are shown in Table 4.

TABLE 4

| | | | | Compar- |
|---|---|---|---|---|
| | | | | ative |
| | | | Example | Example |
| | | | 1 | 1 |
| Compo- sition of catalyst | 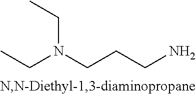 | [wt %] | 74.6 | 100 |
| | Water | | 8.3 | 0 |
| | Carbon dioxide gas | | 17.1 | 0 |
| Parts of | [parts by weight] | [parts | 4.02 | 3.00 |
| catalyst | | by | | |
| Parts of | [parts by weight] | weight] | 3.00 | 3.00 |
| amine | | | | |
| Cream | Before storage | [sec] | 5 | 9 |
| time | After storage at 40° C. for 7 days | | 5 | 10 |
| Core | Before storage | [kg/m³] | 33.1 | 32.9 |
| density | After storage at 40° C. for 7 days | | 33.3 | 35.1 |

TABLE 5

| | | | Example | Comparative |
|---|---|---|---|---|
| | | | 2 | Example 2 |
| Composition of catalyst | 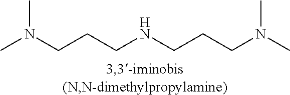 | [wt %] | 81.9 | 100 |
| | Water | | 7.9 | 0 |
| | Carbon dioxide gas | | 10.3 | 0 |
| Parts of | [parts by weight] | [parts by | 3.66 | 3.00 |
| catalyst | | weight] | | |
| Parts of | [parts by weight] | | 3.00 | 3.00 |
| amine | | | | |
| Cream time | Before storage | [sec] | 4 | 7 |
| | After storage at 40° C. for 7 days | | 6 | 9 |
| Core density | Before storage | [kg/m³] | 36.6 | 36.7 |
| | After storage at 40° C. for 7 days | | 35.9 | 35.8 |

TABLE 6

| | | | Example | Comparative |
|---|---|---|---|---|
| | | | 3 | Example 3 |
| Composition of catalyst | 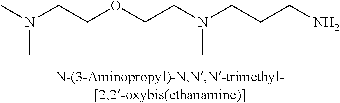 | [wt %] | 82.9 | 100 |
| | Water | | 7.3 | 0 |
| | Carbon dioxide gas | | 9.8 | 0 |
| Parts of | [parts by weight] | [parts | 3.62 | 3.00 |
| catalyst | | by | | |
| Parts of | [parts by weight] | weight] | 3.00 | 3.00 |
| amine | | | | |
| Cream time | Before storage | [sec] | 4 | 6 |
| | After storage at 40° C. for 7 days | | 5 | 9 |
| Core density | Before storage | [kg/m³] | 34.4 | 35.3 |
| | After storage at 40° C. for 7 days | | 34.8 | 36.2 |

### Production Example 4

The same operation as in Production Example 1 was conducted except that 17.4 g (0.15 mol) of N,N-diethyl-1,2-diaminoethane (manufactured by Tokyo Chemical Industry Co., Ltd.) and 2.7 g (0.15 mol) of pure water were used instead of 26.0 g (0.20 mol) of N,N-diethyl-1,3-diaminopropane (manufactured by Tokyo Chemical Industry Co., Ltd.) and 3.6 g (0.20 mol) of pure water, to obtain 24.7 g of reaction liquid (aqueous N,N-diethyl-1,2-diaminoethane carbonate solution).

The composition of the reaction liquid was estimated as follows from the weight of the carbon dioxide absorbed.
N,N-Diethyl-1,2-diaminoethane: 70.5 wt %
Pure water: 10.9 wt %
Carbon dioxide: 18.5 wt %

This composition is taken as (A-4).

### Production Example 5

The same operation as in Production Example 1 was conducted except that 14.4 g (0.10 mol) of N,N-diisopropyl-1,2-diaminoethane (manufactured by Tokyo Chemical Industry Co., Ltd.) and 1.8 g (0.10 mol) of pure water were used instead of 26.0 g (0.20 mol) of N,N-diethyl-1,3-diaminopropane (manufactured by Tokyo Chemical Industry Co., Ltd.) and 3.6 g (0.20 mol) of pure water to obtain 19.5 g of reaction liquid (aqueous N,N-diisopropyl-1,2-diaminoethane carbonate solution).

The composition of the reaction liquid was estimated as follows from the weight of the carbon dioxide absorbed.
N,N-Diisopropyl-1,2-diaminoethane: 74.0 wt %
Pure water: 9.2 wt %
Carbon dioxide: 16.7 wt %

This composition is taken as (A-5).

### Production Example 6

The same operation as in Production Example 1 was conducted except that 9.4 g (0.20 mol) of 2-aminoethanol (manufactured by Tokyo Chemical Industry Co., Ltd.) was used instead of 26.0 g (0.20 mol) of N,N-diethyl-1,3-diaminopropane (manufactured by Tokyo Chemical Industry Co., Ltd.) to obtain 17.2 g of reaction liquid (aqueous 2-aminoethanol carbonate solution).

The composition of the reaction liquid was estimated as follows from the weight of the carbon dioxide absorbed.
2-Aminoethanol: 61.6 wt %
Pure water: 18.2 wt %
Carbon dioxide: 20.2 wt %

This composition is taken as (A-6).

### Production Example 7

The same operation as in Production Example 1 was conducted except that 12.2 g (0.20 mol) of 2-(methylamino)ethanol (manufactured by Tokyo Chemical Industry Co., Ltd.) was used instead of 26.0 g (0.20 mol) of N,N-diethyl-1,3-diaminopropane (manufactured by Tokyo Chemical Industry Co., Ltd.) to obtain 19.9 g of reaction liquid (aqueous 2-(methylamino)ethanol carbonate solution).

The composition of the reaction liquid was estimated as follows from the weight of the carbon dioxide absorbed.
2-(Methylamino)ethanol: 64.2 wt %
Pure water: 15.4 wt %
Carbon dioxide: 20.4 wt %

This composition is taken as (A-7).

### Production Example 8

The same operation as in Production Example 1 was conducted except that 17.8 g (0.20 mol) of 2-(dimethylamino)ethanol (manufactured by Tokyo Chemical Industry Co., Ltd.) was used instead of 26.0 g (0.20 mol) of N,N-diethyl-1,3-diaminopropane (manufactured by Tokyo Chemical Industry Co., Ltd.) to obtain 23.5 g of reaction liquid (aqueous 2-(dimethylamino)ethanol carbonate solution).

The composition of the reaction liquid was estimated as follows from the weight of the carbon dioxide absorbed.
2-(Dimethylamino)ethanol: 75.8 wt %
Pure water: 15.3 wt %
Carbon dioxide: 8.9 wt %

This composition is taken as (A-8).

### Production Example 9

The same operation as in Production Example 1 was conducted except that 20.4 g (0.20 mol) of N,N-dimethyl-1,3-diaminopropane (manufactured by Tokyo Chemical Industry Co., Ltd.) was used instead of 26.0 g (0.20 mol) of N,N-diethyl-1,3-diaminopropane (manufactured by Tokyo Chemical Industry Co., Ltd.) to obtain 31.4 g of reaction liquid (aqueous N,N-dimethyl-1,3-diaminopropane carbonate solution).

The composition of the reaction liquid was estimated as follows from the weight of the carbon dioxide absorbed.
N,N-Dimethyl-1,3-diaminopropane: 65.1 wt %
Pure water: 23.4 wt %
Carbon dioxide: 11.5 wt %

This composition is taken as (A-9).

### Production Example 10

The same operation as in Production Example 1 was conducted except that 13.2 g (0.15 mol) of N,N-dimethyl-1,2-diaminoethane (manufactured by Tokyo Chemical Industry Co., Ltd.) and 2.7 g (0.15 mol) of pure water were used instead of 26.0 g (0.20 mol) of N,N-diethyl-1,3-diaminopropane (manufactured by Tokyo Chemical Industry Co., Ltd.) and 3.6 g (0.20 mol) of pure water to obtain 31.4 g of reaction liquid (aqueous N,N-dimethyl-1,2-diaminoethane carbonate solution).

The composition of the reaction liquid was estimated as follows from the weight of the carbon dioxide absorbed.
N,N-Dimethyl-1,2-diaminoethane: 62.0 wt %
Pure water: 25.3 wt %
Carbon dioxide: 12.7 wt %

This composition is taken as (A-10).

### Example 4

The same operation as in Example 1 was conducted except that the composition (A-4) was used instead of the composition (A-1) and the addition amounts were changed, to produce a polyol blended liquid composition having the following composition.

TABLE 7

| | Content (parts |
|---|---|
| | by weight) |
| Polyol (A + B) | 100 |
| Flame retardant (TMCPP) | 20 |
| Foam stabilizer A (NIAX SILICONE L-5420) | 2 |
| Amine carbonate in composition (A-4) | 3.79 |
| (excluding water) | |
| Blowing agent B (water) | 2 |
| 1-Chloro-3,3,3-trifluoropropene | 15 |

Using the produced polyol blended liquid composition, blowing reaction was conducted under the same conditions as in Example 1, and evaluation was conducted in the same manner as in Example 1. The results are shown in Table.

TABLE 8

| | | | Example 4 |
|---|---|---|---|
| Composition of catalyst | 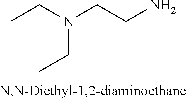 | [wt (%)] | 70.5 |
| | Water | | 10.9 |
| | Carbon dioxide gas | | 18.5 |
| Parts of | [parts by weight] | [parts by | 4.25 |
| catalyst | | weight] | |
| Parts of | [parts by weight] | | 3.00 |
| amine | | | |
| Cream time | Before storage | [sec] | 5 |
| | After storage at 40° C. for 7 days | | 5 |
| Core density | Before storage | [Kg/m³] | 35.3 |
| | After storage at 40° C. for 7 days | | 36.2 |

### Example 5

The same operation as in Example 1 was conducted except that the composition (A-5) was used instead of the composition (A-1) and the addition amounts were changed, to produce a polyol blended liquid composition having the following composition.

TABLE 9

| | Content (parts |
|---|---|
| | by weight) |
| Polyol (A + B) | 100 |
| Flame retardant (TMCPP) | 20 |
| Foam stabilizer A (NIAX SILICONE L-5420) | 2 |
| Amine carbonate in composition (A-5) | 3.68 |
| (excluding water) | |
| Blowing agent B (water) | 2 |
| 1-Chloro-3,3,3-trifluoropropene | 15 |

Using the produced polyol blended liquid composition, blowing reaction was conducted under the same conditions as in Example 1, and evaluation was conducted in the same manner as in Example 1. The results are shown in Table.

TABLE 10

| | | | Example 5 |
|---|---|---|---|
| Composition of catalyst | 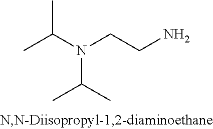 | [wt (%)] | 74.0 |
| | Water | | 9.2 |
| | Carbon dioxide gas | | 16.7 |
| Parts of | [parts by weight] | [parts by | 4.05 |
| catalyst | | weight] | |
| Parts of | [parts by weight] | | 3.00 |
| amine | | | |
| Cream time | Before storage | [sec] | 5 |
| | After storage at 40° C. for 7 days | | 5 |
| Core density | Before storage | [Kg/m³] | 32.5 |
| | After storage at 40° C. for 7 days | | 33.7 |

### Comparative Example 4

The same operation as in Example 1 was conducted except that the composition (A-6) was used instead of the composition (A-1) and the addition amounts were changed, to produce a polyol blended liquid composition having the following composition.

TABLE 11

| | Content (parts |
|---|---|
| | by weight) |
| Polyol (A + B) | 100 |
| Flame retardant (TMCPP) | 20 |
| Foam stabilizer A (NIAX SILICONE L-5420) | 2 |
| Amine carbonate in composition (A-6) | 3.98 |
| (excluding water) | |
| Blowing agent B (water) | 2 |
| 1-Chloro-3,3,3-trifluoropropene | 15 |

Using the produced polyol blended liquid composition, blowing reaction was conducted under the same conditions as in Example 1, and evaluation was conducted in the same manner as in Example 1. The results are shown in Table.

TABLE 12

| | | | Comparative |
|---|---|---|---|
| | | | Example 4 |
| Compo- sition of catalyst | 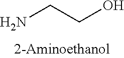 | [wt (%)] | 61.6 |
| | Water | | 18.2 |
| | Carbon dioxide gas | | 20.2 |
| Parts of | [parts by weight] | [parts by | 4.86 |
| catalyst | | weight] | |
| Parts of | [parts by weight] | | 3.00 |
| amine | | | |
| Cream | Before storage | [sec] | 8 |
| time | After storage at 40° C. for 7 days | | 11 |
| Core | Before storage | [Kg/m³] | 35.4 |
| density | After storage at 40° C. for 7 days | | 43.5 |

### Comparative Example 5

The same operation as in Example 1 was conducted except that the composition (A-7) was used instead of the composition (A-1) and the addition amounts were changed, to produce a polyol blended liquid composition having the following composition.

TABLE 13

| | Content (parts |
|---|---|
| | by weight) |
| Polyol (A + B) | 100 |
| Flame retardant (TMCPP) | 20 |
| Foam stabilizer A (NIAX SILICONE L-5420) | 2 |
| Amine carbonate in composition (A-7) | 3.95 |
| (excluding water) | |
| Blowing agent B (water) | 2 |
| 1-Chloro-3,3,3-trifluoropropene | 15 |

Using the produced polyol blended liquid composition, blowing reaction was conducted under the same conditions as in Example 1, and evaluation was conducted in the same manner as in Example 1. The results are shown in Table.

TABLE 14

| | | | Comparative |
|---|---|---|---|
| | | | Example 5 |
| Composition of catalyst | 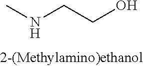 | [wt (%)] | 64.2 |
| | Water | | 15.4 |
| | Carbon dioxide gas | | 20.4 |
| Parts of | [parts by weight] | [parts | 4.67 |
| catalyst | | by | |
| Parts of | [parts by weight] | weight] | 3.00 |
| amine | | | |
| Cream time | Before storage | [sec] | 8 |
| | After storage at 40° C. for 7 days | | 11 |
| Core density | Before storage | [Kg/m³] | 33.5 |
| | After storage at 40° C. for 7 days | | 37.4 |

### Comparative Example 6

The same operation as in Example 1 was conducted except that the composition (A-8) was used instead of the composition (A-1) and the addition amounts were changed, to produce a polyol blended liquid composition having the following composition.

TABLE 15

| | Content (parts |
|---|---|
| | by weight) |
| Polyol (A + B) | 100 |
| Flame retardant (TMCPP) | 20 |
| Foam stabilizer A (NIAX SILICONE L-5420) | 2 |
| Amine carbonate in composition (A-8) | 3.35 |
| (excluding water) | |
| Blowing agent B (water) | 2 |
| 1-Chloro-3,3,3-trifluoropropene | 15 |

Using the produced polyol blended liquid composition, blowing reaction was conducted under the same conditions as in Example 1, and evaluation was conducted in the same manner as in Example 1. The results are shown in Table.

TABLE 16

| | | | Comparative |
|---|---|---|---|
| | | | Example 6 |
| Composition of catalyst | 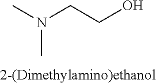 | [wt (%)] | 75.8 |
| | Water | | 15.3 |
| | Carbon dioxide gas | | 8.9 |
| Parts of | [parts by weight] | [parts | 3.96 |
| catalyst | | by | |
| Parts of | [parts by weight] | weight] | 3.00 |
| amine | | | |
| Cream time | Before storage | [sec] | 3 |
| | After storage at 40° C. for 7 days | | 7 |
| Core density | Before storage | [Kg/m³] | 36.1 |
| | After storage at 40° C. for 7 days | | 40.1 |

### Comparative Example 7

The same operation as in Example 1 was conducted except that the composition (A-9) was used instead of the composition (A-1) and the addition amounts were changed, to produce a polyol blended liquid composition having the following composition.

TABLE 17

| | Content (parts |
|---|---|
| | by weight) |
| Polyol (A + B) | 100 |
| Flame retardant (TMCPP) | 20 |
| Foam stabilizer A (NIAX SILICONE L-5420) | 2 |
| Amine carbonate in composition (A-9) | 4.08 |
| (excluding water) | |
| Blowing agent B (water) | 2 |
| 1-Chloro-3,3,3-trifluoropropene | 15 |

Using the produced polyol blended liquid composition, blowing reaction was conducted under the same conditions as in Example 1, and evaluation was conducted in the same manner as in Example 1. The results are shown in Table.

TABLE 18

| | | | Comparative |
|---|---|---|---|
| | | | Example 7 |
| Composition of catalyst | 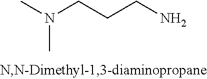 | [wt (%)] | 65.1 |
| | Water | | 11.5 |
| | Carbon dioxide gas | | 23.4 |
| Parts of | [parts by weight] | [parts by | 4.54 |
| catalyst | | weight] | |
| Parts of | [parts by weight] | | 3.00 |
| amine | | | |
| Cream time | Before storage | [sec] | 4 |
| | After storage at 40° C. for 7 days | | 7 |
| Core density | Before storage | [Kg/m³] | 34.4 |
| | After storage at 40° C. for 7 days | | 42.4 |

### Comparative Example 8

The same operation as in Example 1 was conducted except that the composition (A-10) was used instead of the composition (A-1) and the addition amounts were changed, to produce a polyol blended liquid composition having the following composition.

TABLE 19

| | Content (parts |
|---|---|
| | by weight) |
| Polyol (A + B) | 100 |
| Flame retardant (TMCPP) | 20 |
| Foam stabilizer A (NIAX SILICONE L-5420) | 2 |
| Amine carbonate in composition (A-10) | 4.22 |
| (excluding water) | |
| Blowing agent B (water) | 2 |
| 1-Chloro-3,3,3-trifluoropropene | 15 |

Using the produced polyol blended liquid composition, blowing reaction was conducted under the same conditions as in Example 1, and evaluation was conducted in the same manner as in Example 1. The results are shown in Table.

TABLE 20

| | | | Comparative |
|---|---|---|---|
| | | | Example 8 |
| Composition of catalyst | 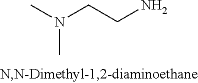 | [wt (%)] | 62.0 |
| | Water | | 12.7 |
| | Carbon dioxide gas | | 25.3 |
| Parts of | [parts by weight] | [parts by | 4.84 |
| catalyst | | weight] | |
| Parts of | [parts by weight] | | 3.00 |
| amine | | | |
| Cream time | Before storage | [sec] | <2 |
| | After storage at 40° C. for 7 days | | 5 |
| Core density | Before storage | [Kg/m³] | — |
| | After storage at 40° C. for 7 days | | 36.8 |

The above results are summarized in Table 21.

TABLE 21

| | | | Example 1 | Example 2 | |
|---|---|---|---|---|---|
| Composition | Amine | wt % | 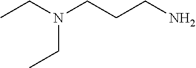 | 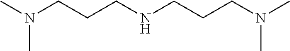 | |
| | | | 74.6 | 81.9 | |
| | Water | | 8.3 | 7.9 | |
| | Carbon dioxide | | 17.1 | 10.3 | |
| | gas | | | | |
| Cream time | Before storage | sec | 5 | 4 | |
| | After storage | | 5 | 6 | |
| Core density | Before storage | kg/m³ | 33.1 | 36.6 | |
| | After storage | | 33.3 | 35.9 | |
| | | | Example 3 | Example 4 | Example 5 |
| Composition | Amine | wt % | 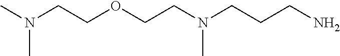 | 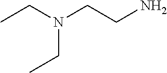 | 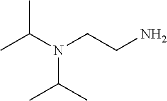 |
| | | | 82.9 | 70.5 | 74.0 |
| | Water | | 7.3 | 10.9 | 9.2 |
| | Carbon dioxide | | 9.8 | 18.5 | 16.7 |
| | gas | | | | |
| Cream time | Before storage | sec | 4 | 5 | 5 |
| | After storage | | 5 | 5 | 5 |
| Core density | Before storage | kg/m³ | 34.4 | 35.3 | 32.5 |
| | After storage | | 34.8 | 36.2 | 33.7 |
| | | | Comparative | Comparative | |
| | | | Example 1 | Example 2 | |
| Composition | Amine | wt % | 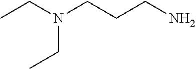 | 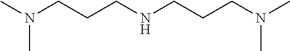 | |
| | | | 100 | 100 | |
| | Water | | 0 | 0 | |
| | Carbon dioxide | | 0 | 0 | |
| | gas | | | | |
| Cream time | Before storage | sec | 9 | 7 | |
| | After storage | | 10 | 9 | |
| Core density | Before storage | kg/m³ | 32.9 | 36.7 | |
| | After storage | | 35.1 | 35.8 | |
| | | | Comparative | Comparative | Comparative |
| | | | Example 3 | Example 4 | Example 5 |
| Composition | Amine | wt % | 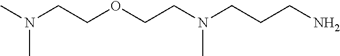 | 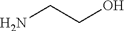 | 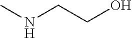 |
| | | | 100 | 61.6 | 64.2 |
| | Water | | 0 | 18.2 | 15.4 |
| | Carbon dioxide | | 0 | 20.2 | 20.4 |
| | gas | | | | |
| Cream time | Before storage | sec | 6 | 8 | 8 |
| | After storage | | 9 | 11 | 11 |
| Core density | Before storage | kg/m³ | 35.3 | 35.4 | 33.5 |
| | After storage | | 36.2 | 43.5 | 37.4 |
| | | | Comparative | Comparative | Comparative |
| | | | Example 6 | Example 7 | Example 8 |
| Composition | Amine | wt % | 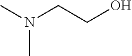 | 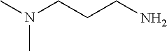 | 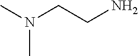 |
| | | | 75.8 | 65.1 | 62.0 |
| | Water | | 15.3 | 23.4 | 12.7 |
| | Carbon dioxide | | 8.9 | 11.5 | 25.3 |
| | gas | | | | |
| Cream time | Before storage | sec | 3 | 4 | <2 |
| | After storage | | 7 | 7 | 5 |
| Core density | Before storage | kg/m³ | 36.1 | 34.4 | — |
| | After storage | | 40.1 | 42.4 | 36.8 |

*Storage condition (40° C. for 7 days)

As evident from Table 21, in Examples 1 to 5 in which the polyol blended liquid composition for production of a polyurethane foam containing the amine carbonate of the present invention was used, the cream time before storage was 5 seconds or shorter and thus the initial blowing tended to be quick. Further, even the cream time after storage was 6 seconds or shorter, and the reaction delay after storage was small.

Whereas in Comparative Examples 1 to 5, the cream time before storage was 6 seconds or longer and thus the initial blowing was slow, and further, the cream time after storage was 9 seconds or longer and the initial blowing was considerably slow.

In Comparative Example 6, the cream time before storage was 3 seconds and the initial blowing was quick, however, the cream time after storage was 7 seconds and a considerable reaction delay was confirmed.

In Comparative Example 7 also, the cream time before storage was 4 seconds and the initial blowing was quick, however, the cream time after storage was 7 seconds and a considerable reaction delay was confirmed.

In Comparative Example 8, the cream time before storage was 2 seconds or shorter and the initial blowing was rather quick, however, a foam which could be subjected to evaluation of physical properties could not be produced. Further, the cream time after storage was 5 seconds, and a considerable reaction delay was confirmed. The change of reactivity was significant, and thus the composition is hardly suitable for industrial application for which stability and reliability are required.

Further, in Examples 1 to 5, the change of the density of the foam as between before and after storage was small, whereas in Comparative Examples 4 to 7, the change of the density of the foam as between before and after storage was large, and such is industrially problematic.

That is, the composition of the present invention has high storage stability and is thereby secure for industrial application for which high reliability is required.

The present invention has been described in detail with reference to specific embodiments, but, it is obvious for the person skilled in the art that various changes and modifications are possible without departing from the intension and the scope of the present invention.

The entire disclosures of Japanese Patent Application No. 2021-080484 filed on May 11, 2021 and Japanese Patent Application No. 2022-051036 filed on Mar. 28, 2022, including specifications, claims, drawings and summaries are incorporated herein by reference in their entireties.

1. A polyol blended liquid composition for production of a polyurethane foam, which comprises:
(i) a carbonate (A) of an amine compound represented by the following formula (1), (2) or (4),
(ii) a blowing agent containing a hydrochlorofluoroolefin (B), and
(iii) a polyol (C): 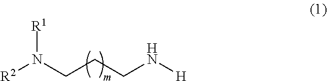
wherein R¹ and R² are each independently a C₂₋₆ alkyl group which may have a hydroxy group,
R¹ and R² may be bonded to form a morpholine ring, and
m is an integer of from 0 to 4; 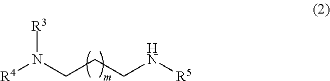
wherein R³ and R⁴ are each independently a C₁₋₆ alkyl group which may have a hydroxy group,
R³ and R⁴ may be bonded to form a morpholine ring,
m is an integer of from 0 to 4, and
R⁵ is a C₁₋₆ alkyl group which may have a hydroxy group, or a group represented by the following formula (3): 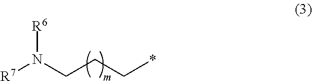
wherein * is a moiety linked to the formula (2),
R⁶ and R⁷ are each independently a C₁₋₆ alkyl group which may have a hydroxy group,
R⁶ and R⁷ may be bonded to form a morpholine ring, and
m is an integer of from 0 to 4; 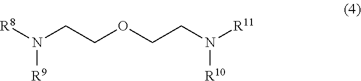
wherein R⁸ and R⁹ are each independently a C₁₋₆ alkyl group which may have a hydroxy group,
R⁸ and R⁹ may be bonded to form a morpholine ring,
R¹⁰ is a hydrogen atom, or a C₁₋₆ alkyl group which may have a hydroxy group,
R¹¹ is a hydrogen atom, a C₁₋₆ alkyl group which may have a hydroxy group, or a group represented by the following formula (5): 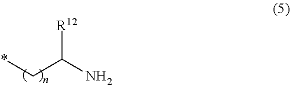
wherein * is a moiety linked to the formula (4),
R¹² is a hydrogen atom or a methyl group, and
n is an integer of from 0 to 2.

2. The composition according to claim 1, wherein in the formula (1), the group represented by —NR¹R² is a diethylamino group, an ethyl(n-propyl)amino group, a di(n-propyl)amino group or a morpholino group.

3. The composition according to claim 1, wherein in the formulae (2) and (3), at least one of the group represented by —NR³R⁴ and the group represented by —NR⁶R⁷, is a dimethylamino group, a diethylamino group, an ethyl(n-propyl)amino group, a di(n-propyl)amino group or a morpholino group.

4. The composition according to claim 1, wherein in the formula (4), the group represented by —NR⁸R⁹ is a dimethylamino group, a diethylamino group, an ethyl(n-propyl)amino group, a di(n-propyl)amino group or a morpholino group.

5. The composition according to claim 1, wherein the carbonate (A) of the amine compound represented by the formula (1), (2) or (4), is a carbonate (A) of at least one amine compound selected from the group consisting of N,N-diethyl-1,2-ethylenediamine, N,N-diethyl-1,3-diaminopropane, N,N-diisopropyl-1,2-ethylenediamine, N,N-isopropyl-1,3-diaminopropane, 4-(2-aminoethyl)morpholine, N-(3-aminopropyl)morpholine, N-(2-aminopropyl)morpholine, N,N-diethyl-N′-methyl-1,2-ethylenediamine, N,N,N′-triethyl-1,2-ethylenediamine, N,N-diethyl-N′-methyl-1,3-propanediamine, N,N,N′-triethyl-1,3-propanediamine, N,N-diethyl-N′-methyl-1,4-butanediamine, N,N,N′-triethyl-1,4-butanediamine, 4-(2-aminoethyl)morpholine, N-(3-aminopropyl)morpholine, N-(2-aminopropyl)morpholine, 3,3′-iminobis(N,N-dimethylpropylamine), 3,3′-iminobis(N,N-diethylpropylamine), 2,2′-iminobis(N,N-diethylethylamine), N-(3-aminopropyl)-N,N′,N′-trimethyl-[2,2′-oxybis(ethylamine)], N-(3-aminopropyl)-N,N′,N′-triethyl-[2,2′-oxybis(ethylamine)] and [2-[2-(diethylamino)ethoxy]ethyl](ethyl)amine.

6. The composition according to claim 1, wherein the carbonate (A) of the amine compound represented by the formula (1), (2) or (4), is a carbonate (A) of at least one amine compound selected from the group consisting of N,N-diethyl-1,2-ethylenediamine, N,N-diethyl-1,3-diaminopropane, N,N-diisopropyl-1,2-ethylenediamine, 3,3′-iminobis(N,N-dimethylpropylamine), 3,3′-iminobis(N,N-diethylpropylamine), 2,2′-iminobis(N,N-diethylethylamine), N-(3-aminopropyl)-N,N′,N′-trimethyl-[2,2′-oxybis(ethylamine)], N-(3-aminopropyl)-N,N′,N′-triethyl-[2,2′-oxybis(ethylamine)] and [2-[2-(diethylamino)ethoxy]ethyl](ethyl)amine.

7. The composition according to claim 1, wherein the hydrochlorofluoroolefin (B) is at least one member selected from the group consisting of 1-chloro-2,3,3,3-tetrafluoropropene, 2-chloro-1,3,3,3-tetrafluoropropene, 1-chloro-1,3,3,3-tetrafluoropropene, 2-chloro-3,3,3-trifluoropropene, 1-chloro-2,3,3-trifluoropropene, 1-chloro-3,3,3-trifluoropropene, 1-chloro-1,3,3-trifluoropropene, 2-chloro-1,3,3-trifluoropropene, 2-chloro-1,1,3-trifluoropropene, 3-chloro-1,2,3-trifluoropropene, 3-chloro-1,1,2-trifluoropropene, 1,2-dichloro-3,3,3-trifluoropropene, 2,3-dichloro-3,3-difluoropropene, 1,2,3-trichloro-3,3-difluoropropene, 2,3-dichloro-1,1-difluoropropene, 2,3,3-trichloro-3-fluoropropene, 1,3-dichloro-2,3,3-trifluoropropene and 1-chloro-2,3,3,4,4,5,5-heptafluoro-1-pentene.

8. The composition according to claim 1, wherein the hydrochlorofluoroolefin (B) is trans-1-chloro-3,3,3-trifluoropropene or 1-chloro-2,3,3,3-tetrafluoropropene.

9. The composition according to claim 1, wherein in the carbonate (A) of the amine compound represented by the formula (1), (2) or (4), the content of carbon dioxide gas as a component of the carbonate, is from 2 to 30 parts by weight per 100 parts by weight of the amine compound represented by the formula (1), (2) or (4).

10. The composition according to claim 1, wherein the weight ratio of the component (A) to the component (C) is such that the component (A) is from 2 to 6 parts by weight per 100 parts by weight of the component (C).

11. The composition according to claim 1, wherein the weight ratio of the component (B) to the component (C) is such that the component (B) is from 10 to 30 parts by weight per 100 parts by weight of the component (C).

12. A method for producing a polyurethane foam, which comprises reacting the composition as defined in claim 1, with a polyisocyanate compound.
